(19) United States
(12) Patent Application Publication
(10) Pub. No.: US 2016/0253655 A1
(43) Pub. Date: Sep. 1, 2016

(54) PAYMENT MEDIA READING DEVICE, CONTROL METHOD OF A PAYMENT MEDIA READING DEVICE, AND A PAYMENT PROCESSING SYSTEM

(71) Applicant: SEIKO EPSON CORPORATION, Tokyo (JP)

(72) Inventor: Kazuyuki YOKOYAMA, Matsumoto-shi (JP)

(73) Assignee: Seiko Epson Corporation, Tokyo (JP)

(21) Appl. No.: 14/911,181

(22) PCT Filed: Nov. 11, 2014
(86) PCT No.: PCT/JP2014/005668

§ 371 Date: Feb. 9, 2016

(30) Foreign Application Priority Data
Nov. 14, 2013 (JP) 2013-236232

(51) Int. Cl. G06Q 20/32; G06Q 20/10; G06Q 20/34; G06Q 20/20

(52) U.S. Cl. CPC G06Q 20/3226; G06Q 20/204; G06Q 20/105; G06Q 20/352

(57) ABSTRACT

More power is acquired without impairing portability.

A payment media reading device connected to the headphone jack a of a mobile terminal has a NFC reading unit that reads payment-related information from payment medium M and inputs the read payment-related information to the microphone input terminal of the headphone jack, and a power supply circuit that acquires power for the NFC reading unit from the audio signals output from the left speaker output terminal of the headphone jack.

Priority is claimed under 35 U.S.C. §119 to Japanese Application No. 2013-236232 filed on Nov. 14, 2013 and under 35 U.S.C. §365 to PCT/JP2014/005668 filed on Nov. 11, 2014.

### TECHNICAL FIELD

The present invention relates to a payment media reading device that connects to the phone jack of a mobile terminal, to a control method therefor, and to a payment processing system.

### BACKGROUND

Payment media reading devices that are used connected to the earphone jack of a smartphone that is used as a payment device are known from the literature (see PTL 1). This payment media reading device reads credit card information by reading magnetic information from a credit card. By inserting and connecting a terminal of the payment media reading device to the earphone jack of a smartphone, credit card information can also be sent from the payment media reading device to the smartphone.

### CITATION LIST

### Patent Literature

PTL 1 JP-A-2013-206256

### SUMMARY OF INVENTION

As new methods of payment have been developed, payment methods using contactless IC cards employing NFC (near-field communication) technologies and devices such as cell phones and smartphones with an embedded wireless IC chip are becoming increasingly common. Incorporating in this type of payment media reading device a wireless media reading unit that reads such wireless IC media is also desirable. However, if a wireless media reading unit is incorporated in the payment media reading device, power must be supplied to drive the wireless media reading unit. This creates a need to supply appropriate power (more power) to the payment media reading device.

Incorporating an internal battery with greater storage capacity and using the battery to supply power is conceivable, but in this case the payment media reading device becomes larger and portability (mobility) is impaired. Alternatively, the payment media reading device could be connected by a cable to an external power source and power supplied from the external power source, but this requires connection through a cable to the external power source, and portability is again impaired.

An objective of the invention is to provide a payment media reading device that can acquire appropriate power without impairing portability, a control method for the payment media reading device, and a payment processing system.

A payment media reading device according to the invention is a payment media reading device that connects to a phone jack of a mobile terminal, and includes: a payment information reading unit that reads payment-related information from payment media, and inputs the read payment-related information to the audio input terminal of the phone jack; and a power acquisition unit that acquires power for the payment information reading unit from audio signals output from the audio output terminal of the phone jack.

Thus comprised, payment-related information is input by audio input to the phone jack, and power is acquired from the audio output of the phone jack. More specifically, because power is acquired from the mobile terminal using the audio output of the connected phone jack, power can be acquired without using a special internal battery or connection to an external power source. As a result, an appropriate power supply (more power) can be acquired without impairing portability. Furthermore, because payment-related information can be input to the mobile terminal and power can be acquired from the mobile terminal by connecting to the headphone jack, there is no need to use a separate cable or terminal to connect to the mobile terminal. Portability is therefore not impaired.

Preferably, the payment information reading unit receives audio signals output from the left or right audio output terminal of the phone jack as control signals; and the power acquisition unit acquires the power from audio signals output from the other of the left and right audio output terminals of the phone jack.

Thus comprised, because control signals can also be exchanged through the phone jack, there is no need to provide a separate connection channel to communicate control signals. The configuration of the payment media reading device is therefore simple.

Further preferably, the payment information reading unit is a wireless media reading unit that reads the payment-related information by near-field communication from payment media having a wireless IC chip.

Thus comprised, power can be appropriately supplied even when the a wireless media reading unit that requires more power to drive is also used.

Further preferably, the payment media reading device also has a magnetic media reading unit that reads payment-related information from magnetic card payment media; and the magnetic media reading unit inputs the read payment-related information to the audio input terminal of the phone jack.

Furthermore, by having magnetic media reading unit in addition to a wireless media reading unit, both wireless IC media and magnetic media can be read. Usability is therefore improved. In addition, because payment-related information is input by the magnetic media reading unit from the audio input terminal of the phone jack, there is no need to provide a separate connection channel for inputting payment-related information from the magnetic media reading unit. The configuration of the payment media reading device is therefore simple.

Further preferably, the power acquisition unit has a rectification unit that rectifies the audio signals to DC signals.

Thus comprised, because the power acquisition unit treats audio signals from the mobile terminal as AC current and converts audio signals to DC current, DC current can be acquired from the audio signals from the mobile terminal. As a result, the payment media reading device can drive the payment information reading unit with DC current. Note that the rectification unit preferably includes a rectifier circuit and a smoothing circuit.

Yet further preferably, the payment media reading device also has a capacitor between the payment information reading unit and the power acquisition unit.

Thus comprised, power acquired by the power acquisition unit can be stored in a capacity, and greater power can be temporarily supplied.

A payment processing system according to the invention includes the payment media reading device described above, and a mobile terminal to the phone jack of which the payment media reading device connects. The mobile terminal has an audio signal output unit that outputs audio signals that become the power of the payment information reading unit from the audio output terminal of the phone jack; a payment information acquisition unit that acquires the payment-related information input to the audio input terminal of the phone jack; and a payment processing unit that runs a payment process based on the acquired payment-related information.

By embedding a specific program in the mobile terminal, this aspect of the invention can provide a payment processing system that supplies sufficient power to the payment media reading device without impairing mobility.

A control method of a payment media reading device according to the invention includes: a payment information reading step of reading payment-related information from payment media, and inputting the read payment-related information to the audio input terminal of the phone jack; and a power acquisition step of acquiring power from audio signals output from the audio output terminal of the phone jack.

In addition, the payment information reading step receives audio signals output from the left or right audio output terminal of the phone jack as control signals; and the power acquisition step acquires the power from audio signals output from the other of the left and right audio output terminals of the phone jack.

### BRIEF DESCRIPTION OF DRAWINGS

FIGS. 1A and 1B illustrate a payment processing system according to an embodiment of the invention.

FIG. 2 is a block diagram illustrating the internal configuration of the mobile terminal and payment media reading device.

FIG. 3 is a flow chart describing the payment processing operation of the payment processing system.

FIG. 4 is a flow chart describing part of the payment processing operation.

FIG. 5 is a block diagram illustrating the internal configuration of the mobile terminal and payment media reading device according to a first variation of the invention.

FIG. 6 is a block diagram illustrating the internal configuration of the mobile terminal and payment media reading device according to a second variation of the invention.

### DETAILED DESCRIPTION

A payment media reading device, a payment processing system using the payment media reading device, and a program according to a preferred embodiment of the invention are described below with reference to the accompanying figures. This payment processing system reads payment-related information from payment media such as credit cards or mobile terminals with an Osaifu Keitai (R) or other mobile wallet function, and executes a payment process. Use in a mobile POS (point-of-sale) system, for example, is anticipated. This payment processing system is built so that it can read both magnetic media, which are payment media in the form of a magnetic card, and wireless IC media, which are payment media with an embedded wireless IC chip. Note that contactless IC cards with a wireless IC chip, and mobile terminals (cell phones and smartphones) with an embedded wireless IC chip, are anticipated as examples of wireless IC media M2.

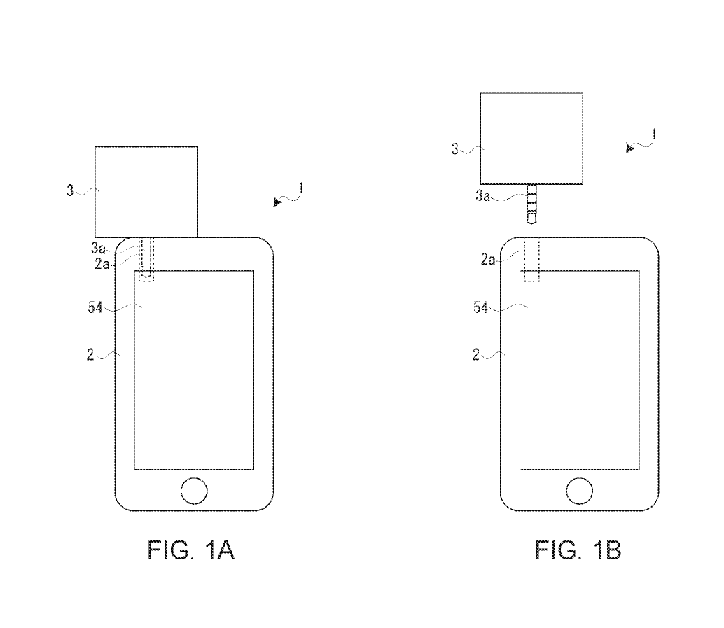

As shown in FIGS. 1A and 1B, the payment processing system 1 includes a mobile terminal 2, and a payment media reading device 3 that connects to the mobile terminal 2. As shown in the figure, the payment media reading device 3 connects to the headphone jack (phone jack) of the mobile terminal 2. More specifically, by inserting the headphone plug 3a of the payment media reading device 3 to the headphone jack 2a of the mobile terminal 2, the payment media reading device 3 is attached to the mobile terminal 2, and the payment media reading device 3 is electrically connected to the mobile terminal 2. When thus connected, payment-related information is read from the payment medium M by the payment media reading device 3, and a payment process is executed by the mobile terminal 2 based on the read information.

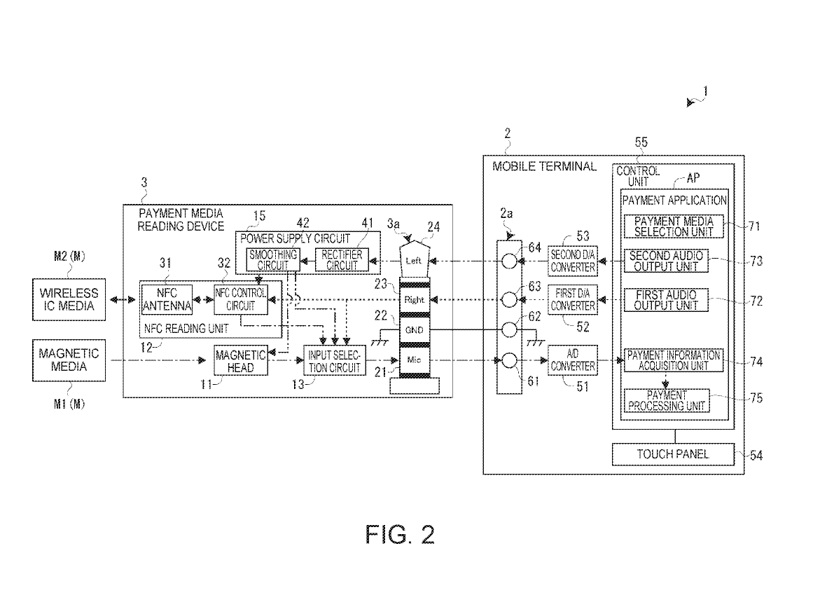

As shown in FIG. 2, the payment media reading device 3 includes the headphone plug 3a, a magnetic head 11 (magnetic media reading unit) that can read magnetic media M1, a NFC reading unit 12 (wireless media reading unit) that can read wireless IC media M2, an input selection circuit 13 intervening between the magnetic head 11 and NFC reading unit 12 and the headphone plug 3a, and a power supply circuit 15 (power acquisition unit) that supplies power to the magnetic head 11, NFC reading unit 12, and input selection circuit 13. Payment-related information read by the magnetic head 11 and NFC reading unit 12 is input through the input selection circuit 13 to the mobile terminal 2 by the headphone plug 3a. Note that in FIG. 2 the path of payment-related information when payment-related information is input is indicated by the dot-dash lines, and the path of control signals related to control of the payment media reading device 3 by the mobile terminal 2 is indicated by the dotted lines. In addition, the path of audio signals related to the power supply from the mobile terminal 2 to the payment media reading device 3, and DC signals converted therefrom, are indicated in FIG. 2 by the double-dot dash lines.

The headphone plug 3a has, in order from the base end, a microphone output terminal 21, a ground terminal 22, a right speaker input terminal 23, and a left speaker input terminal 24. By inserting the headphone plug 3a to the headphone jack 2a of the mobile terminal 2, the microphone output terminal 21, ground terminal 22, right speaker input terminal 23, and left speaker input terminal 24 are respectively connected to the microphone input terminal 61, ground terminal 62, right speaker output terminal 63, and left speaker output terminal 64 of the headphone jack 2a.

The magnetic head 11 has a reading slot (not shown in the figure), and reads payment-related information from magnetic media M1 by reading the magnetic information when the magnetic media M1 is swiped through the reading slot. For example, credit information (credit card ID) stored in magnetic media M1 is read as the payment-related information. The magnetic head 11 also inputs the read payment-related information to the headphone jack 2a of the mobile terminal 2 through the input selection circuit 13 and headphone plug 3a. More specifically, payment-related information read by the magnetic head 11 is input through the microphone output terminal 21 of the headphone plug 3a to the microphone input terminal 61 of the headphone jack 2a.

The NFC reading unit 12 includes a NFC antenna 31, and a NFC control circuit 32 that controls the NFC antenna 31. The NFC antenna 31 exchanges information with wireless IC media M2 by near-field communication.

The NFC control circuit 32 controls communication by the NFC antenna 31, and reads payment-related information from wireless IC media M2 by near-field communication. For example, the unique ID of the wireless IC chip embedded in the wireless IC media M2, type information for applications embedded in the wireless IC chip, authentication information for each application, and a payment ID for each application, are read as payment-related information. The NFC control circuit 32 inputs the read payment-related information through the input selection circuit 13 and headphone plug 3a to the headphone jack 2a of the mobile terminal 2. More specifically, payment-related information read by the NFC control circuit 32 is input through the microphone output terminal 21 of the headphone plug 3a to the microphone input terminal 61 of the headphone jack 2a.

The NFC control circuit 32 can also receive control signals from the mobile terminal 2. Specifically, the NFC control circuit 32 is connected to the right speaker output terminal 63 of the headphone jack 2a through the right speaker input terminal 23 of the headphone plug 3a, and receives audio signals output from the right speaker output terminal 63 as control signals. As a result, the NFC control circuit 32 is controlled based on commands from the mobile terminal 2.

The input selection circuit 13 is disposed between the magnetic head 11 and NFC control circuit 32 and the headphone plug 3a, and changes the connection to the headphone plug 3a to the magnetic head 11 or the NFC control circuit 32. As a result, the input selection circuit 13 changes the reading unit that inputs payment-related information to the microphone input terminal 61 to the magnetic head 11 or the NFC reading unit 12. The input selection circuit 13 can also receive control signals from the mobile terminal 2. More specifically, like the NFC control circuit 32, the input selection circuit 13 is connected through the right speaker input terminal 23 of the headphone plug 3a to the right speaker output terminal 63 of the headphone jack 2a, and audio signals output from the right speaker output terminal 63 are received as control signals. As a result, the input selection circuit 13 is controlled based on commands from the mobile terminal 2. Note that the reading unit that inputs payment-related information is set to the magnetic head 11 by the input selection circuit 13 in the default state before a control signal is received.

The power supply circuit 15 gets power from the mobile terminal 2, and supplies power to the magnetic head 11, NFC control circuit 32, and input selection circuit 13. The power supply circuit 15 acquires power for the magnetic head 11, NFC control circuit 32, and input selection circuit 13 from the audio signals output from the left speaker output terminal 64 of the headphone jack 2a. More specifically, the power supply circuit 15 includes a rectifier circuit 41 connected to the left speaker input terminal 24 of the headphone plug 3a, and a smoothing circuit 42 connected to the output side of the rectifier circuit 41. The rectifier circuit 41 rectifies and converts audio signals output from the left speaker output terminal 64 of the headphone jack 2a to DC signals, and the smoothing circuit 42 smoothes the DC signals and then outputs the DC signals to the magnetic head 11, NFC control circuit 32, and input selection circuit 13. Note that a rectification unit is embodied by the rectifier circuit 41 and smoothing circuit 42.

The mobile terminal 2 is described next. The mobile terminal 2 is a common smartphone, and includes the headphone jack 2a described above, an A/D converter 51 connected to the microphone input terminal 61 of the headphone jack 2a, a first D/A converter 52 connected to the right speaker output terminal 63 of the headphone jack 2a, a second D/A converter 53 connected to the left speaker output terminal 64 of the headphone jack 2a, a touch panel 54 for displaying information and receiving operating input, and a control unit 55 that controls parts of the mobile terminal 2.

The headphone jack 2a includes a microphone input terminal (audio input terminal) 61, ground terminal 62, right speaker output terminal (audio output terminal) 63, and left speaker output terminal (audio output terminal) 64. As described above, by inserting the headphone plug 3a of the payment media reading device 3 to the headphone jack 2a, the microphone input terminal 61, ground terminal 62, right speaker output terminal 63 and left speaker output terminal 64 are respectively connected to the microphone output terminal 21, ground terminal 22, right speaker input terminal 23, and left speaker input terminal 24 of the headphone plug 3a.

The A/D converter 51 converts signals input to the microphone input terminal 61 from analog signals to digital signals. The first D/A converter 52 converts signals output from the right speaker output terminal 63 from digital signals to analog signals. The second D/A converter 53 converts signals output from the left speaker output terminal 64 from digital signals to analog signals.

The control unit 55 includes a CPU (Central Processing Unit), ROM (Read Only Memory), RAM (Random Access Memory), and controls parts of the mobile terminal 2. A payment application AP for executing a payment process based on the payment medium M is installed in the control unit 55. The mobile terminal 2 functions as a payment processing device as a result of the control unit 55 running the payment application AP.

The payment application AP includes a payment media selection unit 71, first audio output unit 72, second audio output unit 73 (audio signal output unit), payment information acquisition unit 74, and payment processing unit 75.

The payment media selection unit 71 selects magnetic media M1 or wireless IC media M2 as the payment medium M to read. The payment media selection unit 71 displays a selection interface (not shown in the figure) for selecting the payment medium M on the touch panel 54, and causes the touch panel 54 to function as a selection means for the user to select the payment medium M.

The first audio output unit 72 outputs audio signals (referred to below as “audio control signals”) received as control signals to the payment media reading device 3. The first audio output unit 72 outputs the audio control signals through the first D/A converter 52 from the right speaker output terminal 63 of the headphone jack 2a to the right speaker input terminal 23 of the headphone plug 3a. As described above, the output audio control signals are received as control signals by the NFC control circuit 32 and input selection circuit 13. The mobile terminal 2 controls the NFC control circuit 32 and input selection circuit 13 by outputting the audio control signals to the NFC control circuit 32 and input selection circuit 13 through the first audio output unit 72.

The second audio output unit 73 outputs audio signals (referred to below as “audio power signals”) that become power for the payment media reading device 3 (magnetic head 11, NFC control circuit 32, and input selection circuit 13) to the payment media reading device 3. More specifically, the second audio output unit 73 outputs audio power signals through the second D/A converter 53 to the left speaker input terminal 24 of the headphone plug 3a from the left speaker output terminal 64 of the headphone jack 2a. As described above, the output audio power signals are converted by the power supply circuit 15 to DC signals, and supplied to the magnetic head 11, NFC control circuit 32, and input selection circuit 13.

The payment information acquisition unit 74 acquires the payment-related information input to the microphone input terminal 61 of the headphone jack 2a. The payment processing unit 75 runs a payment process based on the payment-related information the payment information acquisition unit 74 acquires. More specifically, the payment processing unit 75 executes the payment process by generating and sending payment request data based on the payment-related information to a payment processing server not shown.

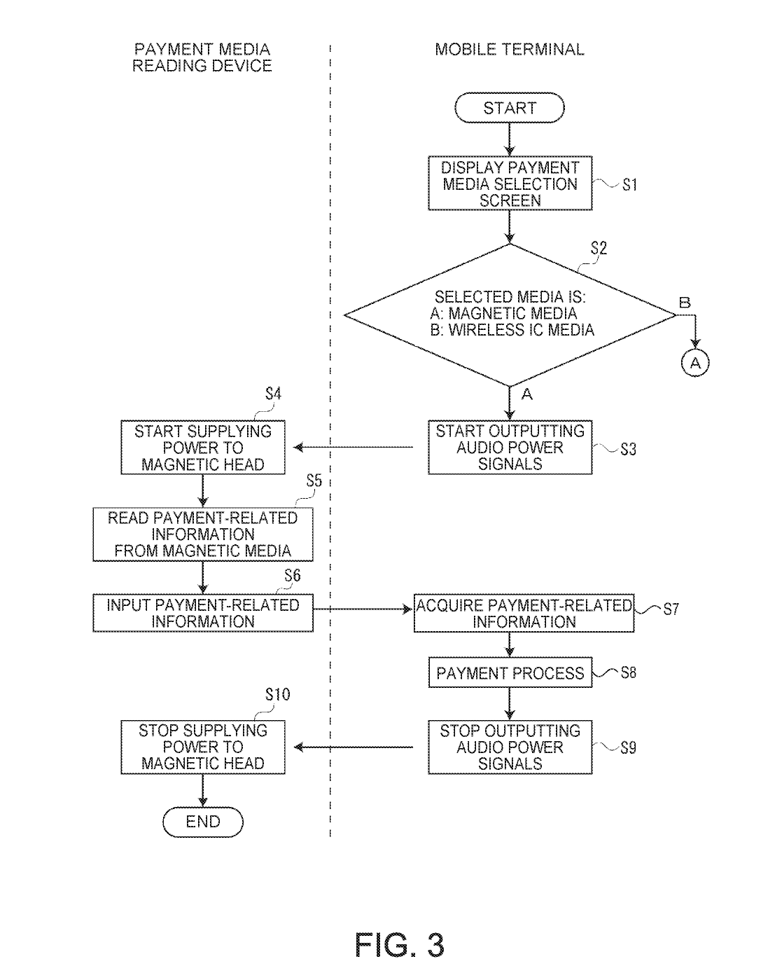

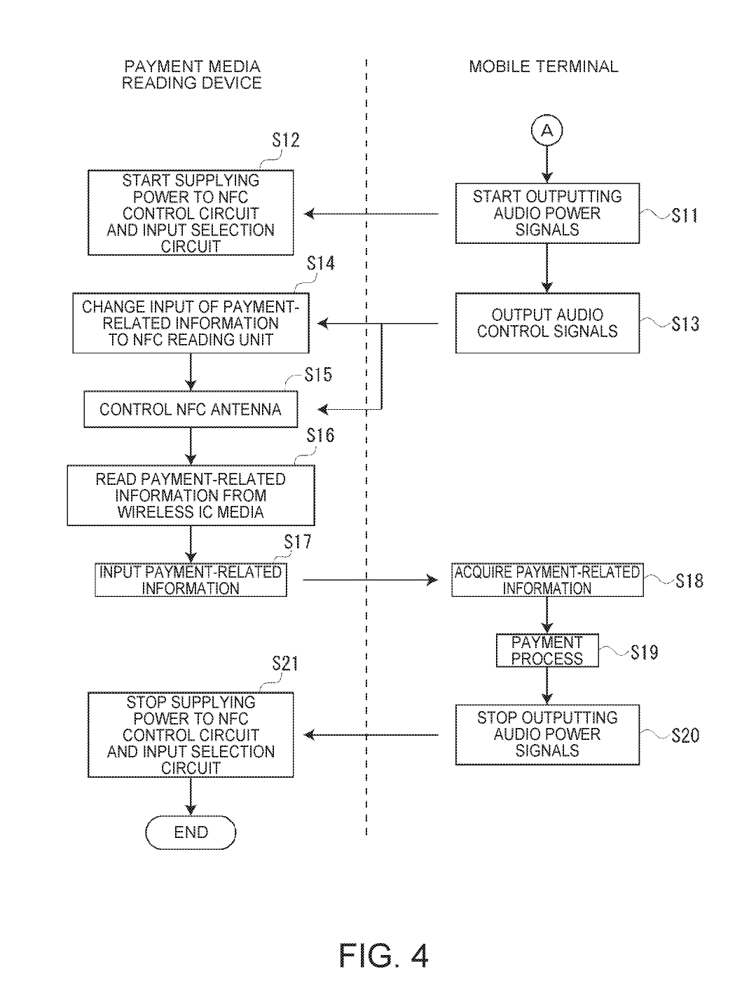

The payment processing operation of the payment processing system 1 is described next with reference to FIG. 3 and FIG. 4. This payment processing operation is executed when the user starts the payment application AP on the mobile terminal 2.

As shown in FIG. 3 and FIG. 4, the mobile terminal 2 first displays a payment medium M selection screen by the payment media selection unit 71 (S1). When the user then selects magnetic media M1 from the selection screen (S2: A), the second audio output unit 73 starts outputting audio power signals to the payment media reading device 3 (S3). More specifically, the second audio output unit 73 outputs audio power signals from the left speaker output terminal 64 of the headphone jack 2a to the left speaker input terminal 24 of the headphone plug 3a. The power supply circuit 15 of the payment media reading device 3 receives the audio power signals input to the left speaker input terminal 24, acquires power from the audio power signals, and starts supplying power to the magnetic head 11 (S4). This supply of power enables the magnetic head 11 to read magnetic media M1. Because the input selection circuit 13 sets the reading unit for inputting payment-related information to the magnetic head 11 in the default state as also described above payment-related information that is read can be input from the magnetic head 11 to the mobile terminal 2 as soon as power is supplied to the magnetic head 11.

When the user then passes magnetic media M1 through the reading slot of the magnetic head 11, and the magnetic head 11 reads the payment-related information of the magnetic media M1 (S5), the payment-related information read by the magnetic head 11 is input to the mobile terminal 2 (S6). More specifically, payment-related information read by the magnetic head 11 is input from the microphone output terminal 21 of the headphone plug 3a to the microphone input terminal 61 of the headphone jack 2a. The payment information acquisition unit 74 of the mobile terminal 2 thus acquires the payment-related information input to the microphone input terminal 61 (S7). The payment processing unit 75 then runs the payment process based on the acquired payment-related information (S8). When the payment process ends, the second audio output unit 73 stops outputting audio power signals (S9), power supply from the power supply circuit 15 to the magnetic head 11 ends (S10), and the payment processing operation ends.

Referring again to S2, when the user selects wireless IC media M2 (S2:B), the second audio output unit 73 first starts outputting audio power signals to the payment media reading device 3 (S11). More specifically, the second audio output unit 73 outputs audio power signals from the left speaker output terminal 64 of the headphone jack 2a to the left speaker input terminal 24 of the headphone plug 3a. The power supply circuit 15 of the payment media reading device 3 thus receives the audio power signals input to the left speaker input terminal 24, acquires power from the audio power signals, and starts supplying power to the NFC control circuit 32 and input selection circuit 13 (S12).

Next, the mobile terminal 2 outputs audio control signals to the payment media reading device 3 from the first audio output unit 72 (S13). More specifically, the first audio output unit 72 outputs audio control signals from the right speaker output terminal 63 of the headphone jack 2a to the right speaker input terminal 23 of the headphone plug 3a. The input selection circuit 13 of the payment media reading device 3 thus receives the audio control signals input to the right speaker input terminal 23, and executes the selection process based on the audio control signals. In other words, the input selection circuit 13 changes the reading unit that inputs payment-related information to the NFC reading unit 12 (S14). The NFC control circuit 32 also receives the audio control signals, and controls the NFC antenna 31 based on the audio control signals (S15). As a result, the NFC reading unit 12 can read wireless IC media M2. Furthermore, because the reading unit that inputs payment-related information is changed to the NFC reading unit 12 by the input selection circuit 13, payment-related information read by the NFC reading unit 12 can be input to the mobile terminal 2.

When then user than swipes wireless IC media M2 over the NFC antenna 31 and the NFC reading unit 12 reads the payment-related information of the wireless IC media M2 (S16), the payment-related information read by the NFC reading unit 12 is input to the mobile terminal 2 (S17). More specifically, the payment-related information read by the NFC reading unit 12 is input from the microphone output terminal 21 of the headphone plug 3a to the microphone input terminal 61 of the headphone jack 2a. The payment information acquisition unit 74 of the mobile terminal 2 thus acquires the payment-related information input to the microphone input terminal 61 (S18). The payment processing unit 75 then runs the payment process based on the acquired payment-related information (S19). When the payment process ends, the second audio output unit 73 stops outputting the audio power signals (S20), power supply from the power supply circuit 15 to the NFC control circuit 32 and input selection circuit 13 ends (S21), and the payment processing operation ends.

Thus comprised, payment-related information is input to the mobile terminal 2 by audio input to the headphone jack 2a, and the payment media reading device 3 receives power from the audio output of the headphone jack 2a. More specifically, because the payment media reading device 3 acquires power from the mobile terminal 2 using audio output from the connected headphone jack 2a, power can be acquired without using a special internal battery or connection to an external power source. As a result, an appropriate power supply (more power) can be acquired without impairing portability. Furthermore, because payment-related information can be input to the mobile terminal 2 and power can be acquired from the mobile terminal 2 by simply connecting to the headphone jack 2a, there is no need to use a separate cable or terminal to connect to the mobile terminal 2. Portability is therefore not impaired.

Furthermore, because the NFC reading unit 12 receives audio signals output from the right speaker output terminal 63 of the headphone jack 2a as control signals, there is no need to provide a separate connection channel to communicate control signals because the payment media reading device 3 also communicates control signals through the headphone jack 2a. The configuration of the payment media reading device 3 is therefore simple.

Furthermore, by having both a magnetic head 11 and a NFC reading unit 12, the payment media reading device 3 can read both magnetic media M1 and wireless IC media M2. Usability is therefore improved. In addition, because payment-related information is input by the magnetic head 11 from the microphone input terminal 61 of the headphone jack 2a, there is no need to provide the payment media reading device 3 with a separate connection channel for inputting payment-related information from the magnetic head 11. The configuration of the payment media reading device 3 is therefore simple.

Yet further, the power supply circuit 15 has a rectifier circuit 41 and a smoothing circuit 42, treats audio signals from the mobile terminal 2 as AC current and converts audio signals to DC current, the payment media reading device 3 can acquire DC current from the audio signals from the mobile terminal 2. As a result, the NFC reading unit 12 can be driven with DC current.

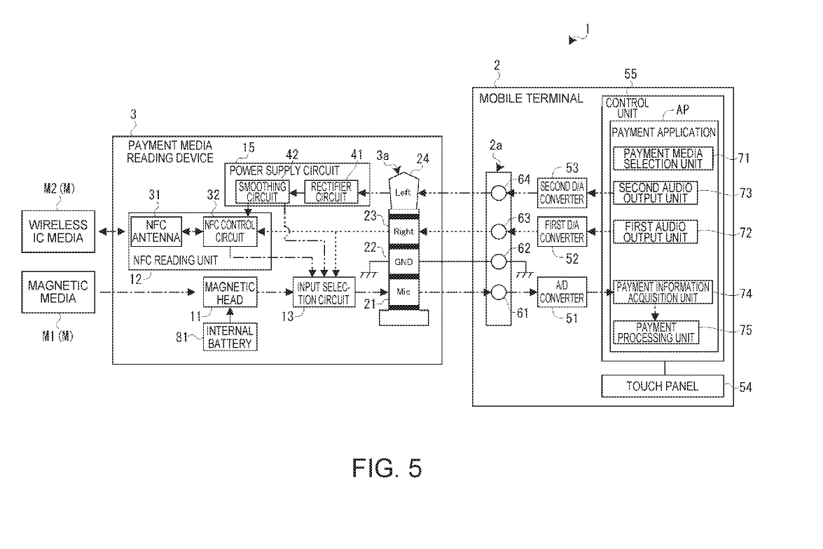

Note that while power is supplied to the magnetic head 11 by the power supply circuit 15 in the above embodiment, a configuration that has an internal battery 81 in the payment media reading device 3, and supplies power to the magnetic head 11 by the internal battery 81, is also conceivable as shown in FIG. 5. More specifically, the magnetic head 11, which requires little drive power, may be configured to acquire power from the mobile terminal 2 by the power supply circuit 15, or to acquire power from the internal battery 81. When the internal battery 81 is used to supply the magnetic head 11, the mobile terminal 2 sends audio power signals by the second audio output unit 73, and the payment media reading device 3 acquires power by the power supply circuit 15, only when a wireless IC device is selected when selecting the payment medium M (S2 in FIG. 3).

In a configuration in which power is supplied to the magnetic head 11 by the internal battery 81 in FIG. 5, the input selection circuit 13 may be configured to execute a switching process based on whether or not power is acquired by the power supply circuit 15. More specifically, the input selection circuit 13 switches to the NFC reading unit 12 when power is acquired by the power supply circuit 15, and switches to the magnetic head 11 when power is not acquired by the power supply circuit 15. Thus comprised, there is no need to output control signals (audio control signals) related to the switching process to the input selection circuit 13, and the related steps can be omitted.

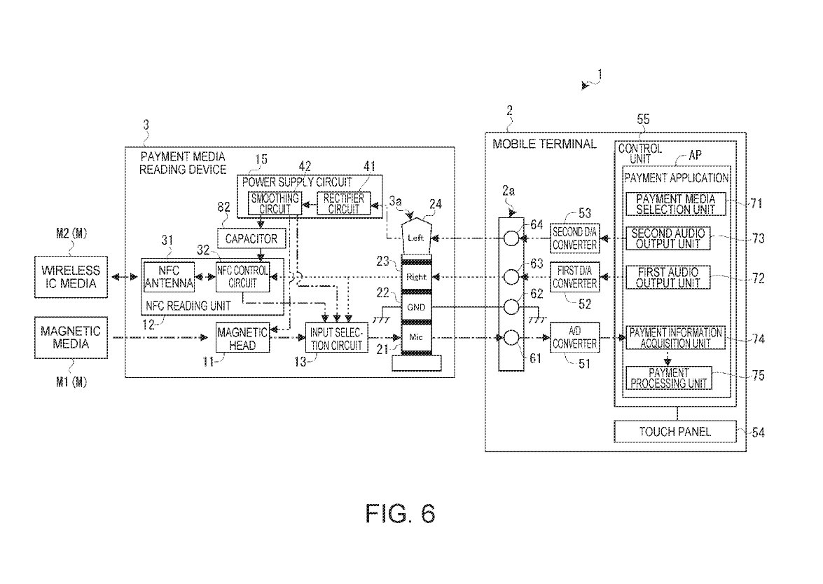

As shown in FIG. 6, the payment media reading device 3 in the embodiment described above may also have a capacitor 82 (storage capacitor) between the power supply circuit 15 and NFC control circuit 32 (NFC reading unit 12). In this configuration, power acquired by the power supply circuit 15 is stored in the capacitor 82, and more power can be supplied temporarily.

Furthermore, the NFC control circuit 32 and input selection circuit 13 in the above embodiment receive audio signals from the right speaker output terminal 63 as control signals, and the power supply circuit 15 converts audio signals from the left speaker output terminal 64 to power, but the roles of the left and right speaker output terminals 63, 64 maybe reversed. More specifically, the NFC control circuit 32 and input selection circuit 13 may receive audio signals from the left speaker output terminal 64 as control signals, and the power supply circuit 15 converts audio signals from the right speaker output terminal 63 to power. In this configuration, the first audio output unit 72 outputs audio power signals, and the second audio output unit 73 outputs audio control signals.

The NFC antenna 31 of the NFC reading unit 12 in the embodiment described above may be inside the reading slot of the magnetic head 11, and the NFC reading unit 12 may read wireless IC media M2 (contactless IC cards) swiped through the reading slot. Thus comprised, the user can read both magnetic media M1 and wireless IC media M2 by the same operation of passing the media through the same reading slot. As a result, the user does not need to check whether the payment medium M is magnetic media M1 or wireless IC media M2, and the step of the user confirming the media can be omitted.

The embodiment described above has a input selection circuit 13 between the magnetic head 11 and NFC reading unit 12 and the headphone plug 3a, but a configuration having an intervening mixing circuit or synthesis circuit instead of the input selection circuit 13 is also conceivable.

Yet further, the payment information reading unit in the above embodiments is embodied by the NFC reading unit 12, but a payment information reading unit may also be embodied by the magnetic head 11. Furthermore, the payment media reading device 3 has both a magnetic head 11 and a NFC reading unit 12 above, but a configuration having only one of the magnetic head 11 and NFC reading unit 12 is also conceivable.

The mobile terminal 2 in the foregoing embodiments is embodied by a smartphone, but the invention is not so limited. For example, the mobile terminal 2 may be a tablet device, cell phone, mobile POS terminal or mobile information terminal (PDA), or a mobile game machine.

### INDUSTRIAL APPLICABILITY

As described above, the present invention is useful for payment media reading devices and payment processing systems, and is particularly suited to reading payment-related information from magnetic media or wireless IC media by a payment media reading device that connects to the phone jack of a mobile terminal, and executing a payment process on the mobile terminal.

1. A payment media reading device that connects to a phone jack of a mobile terminal, comprising:
a payment information reading unit that reads payment-related information from payment media, and inputs the read payment-related information to the audio input terminal of the phone jack; and
a power acquisition unit that acquires power for the payment information reading unit from audio signals output from the audio output terminal of the phone jack.

2. The payment media reading device described in claim 1, wherein:
the payment information reading unit receives audio signals output from the left or right audio output terminal of the phone jack as control signals; and
the power acquisition unit acquires the power from audio signals output from the other of the left and right audio output terminals of the phone jack.

3. The payment media reading device described in claim 1, wherein:
the payment information reading unit is a wireless media reading unit that reads the payment-related information by near-field communication from payment media having a wireless IC chip.

4. The payment media reading device described in claim 1, further comprising:
a magnetic media reading unit that reads payment-related information from magnetic card payment media; and
the magnetic media reading unit inputs the read payment-related information to the audio input terminal of the phone jack.

5. The payment media reading device described in claim 1, wherein:
the power acquisition unit has a rectification unit that rectifies the audio signals to DC signals.

6. The payment media reading device described in claim 1, further comprising:
a capacitor between the payment information reading unit and the power acquisition unit.

7. A control method of a payment media reading device that connects to a phone jack of a mobile terminal, comprising:
a payment information reading step of reading payment-related information from payment media, and inputting the read payment-related information to the audio input terminal of the phone jack; and
a power acquisition step of acquiring power from audio signals output from the audio output terminal of the phone jack.

8. The control method of a payment media reading device described in claim 7, wherein:
the payment information reading step receives audio signals output from the left or right audio output terminal of the phone jack as control signals; and
the power acquisition step acquires the power from audio signals output from the other of the left and right audio output terminals of the phone jack.

9. The control method of a payment media reading device described in claim 7, wherein:
the payment information reading step reads the payment-related information by near-field communication from payment media having a wireless IC chip.

10. The control method of a payment media reading device described in claim 7, wherein:
the payment information reading step reads the payment-related information from magnetic card payment media, and
inputs the read payment-related information to the audio input terminal of the phone jack.

11. A payment processing system comprising:
the payment media reading device described claim 1; and
the mobile terminal to the phone jack of which the payment media reading device connects;
the mobile terminal having an audio signal output unit that outputs audio signals that become the power of the payment information reading unit from the audio output terminal of the phone jack,
a payment information acquisition unit that acquires the payment-related information input to the audio input terminal of the phone jack, and
a payment processing unit that runs a payment process based on the acquired payment-related information.
